(19) United States
(12) Patent Application Publication
(10) Pub. No.: US 2008/0302753 A1
(43) Pub. Date: Dec. 11, 2008

(54) APPARATUS AND METHOD FOR PRODUCING A CONTAINER CLOSURE

(75) Inventors: David J. Jochem, Evansville, IN (US); John Gentile, Lititz, PA (US); Steven Gibble, Manheim, PA (US)

Correspondence Address: BARNES & THORNBURG LLP, 11 SOUTH MERIDIAN, INDIANAPOLIS, IN, 46204, US

(73) Assignee: Berry Plastics Corporation, Evansville, IN (US)

(21) Appl. No.: 12/133,838

(22) Filed: Jun. 5, 2008

Related U.S. Application Data
(60) Provisional application No. 60/942,930, filed on Jun. 8, 2007.

(51) Int. Cl. B65D 41/00; B65D 41/02; B29C 43/00

(52) U.S. Cl. 215/228; 215/316; 264/337

(57) ABSTRACT

A process of producing a container closure by molding a gob of elastomeric material in a mold cavity

This application claims priority under 35 U.S.C. § 119(e) to U.S. Provisional Application Ser. No. 60/942,930, filed Jun. 8, 2007, which is expressly incorporated by reference herein.

### BACKGROUND

The present disclosure relates to a closure for a liquid container, and particularly to a closure configured to close an open mouth formed in a threaded neck of a beverage container. More particularly, the present disclosure relates to a container closure made of both hard and relatively softer materials and apparatus and methods for making such a container closure using a compression molding process.

Milk, juice, and other beverages are dispensed into jugs or containers at a bottling plant. A closure is then mounted on the container neck to close a liquid inlet/outlet opening formed in the container neck. Closures are sized and shaped to mate with container necks to minimize leakage of liquid from a closed container during shipment of filled containers from a bottling plant to a wholesale or retail store.

Some beverage containers, such as one gallon milk or orange juice jugs, are extrusion blow-molded using a polyethylene plastics material. Other beverage containers of the type used to store sport drinks are stretch blow-molded using a PET plastics material. In most cases, external threads are formed on the open-mouth necks of these containers to mate with a container closure formed to include mating internal threads.

Container closures are usually made of low-density polyethylene (LDPE), high-density polyethylene (HDPE), or polypropylene (PP) and some closures are configured to be snapped onto the neck using a capping machine at the bottling plant and screwed on and off the neck by a consumer at home or elsewhere. Such snap-on, screw-off style closures often include many fine interior threads with many separate thread leads to enable a bottler to close the open mouth formed in the container neck by applying downward pressure on the closure to snap it into place on the neck of a filled container. Nevertheless, a consumer is able to twist and unscrew the threaded closure to remove it from the threaded neck of the container to access the liquid in the container.

### SUMMARY

In accordance with the present disclosure, a process of molding a container closure comprises depositing a gob of elastomeric material in a mold cavity defined between upper and lower mold portions and then deforming the gob in the mold cavity to produce a grip portion overmolded onto a cap made of a plastics material. Compression molding apparatus and methods in accordance with the present disclosure are used to deform the gob of elastomeric material in the mold cavity.

In illustrative embodiments, a closure mold includes an upper mold portion that mates with an underlying lower mold portion to form a sealed material-compression space therebetween. The upper mold portion includes an inverted cap mounted on a workpiece holder and provided with a side wall trapped between the workpiece holder and a surrounding outer sleeve to establish a fluid-tight annular seal between the inverted cap and the surrounding outer sleeve. When the upper mold portion is mated with the lower mold portion, the inverted cap, the outer sleeve, and the lower mold portion cooperate to define a sealed material-compression space.

In illustrative processes, a gob of elastomeric material is placed in a cavity formed in the lower mold portion so that it will be compressed in the sealed material-compression space during the overmolding process disclosed herein. The gob is squeezed between the stationary lower mold portion and the downwardly moving inverted cap to cause the elastomeric material to flow along the top wall and side wall of the cap and to fill some but not all of the sealed material-compressing space in response to downward movement of the upper mold portion to cause the outer sleeve to mate with the lower mold portion during an illustrative first stage of compression molding. In an illustrative second stage of compression molding, the inverted cap is moved downwardly further into the cavity formed in the lower mold portion to squeeze the elastomeric material even more. Such squeezing causes the elastomeric material to deform further and flow along the top wall and side wall of the cap to fill all of the sealed material-compression space so as to form an overmolded relatively soft outer grip portion therein on top wall and side wall portions of the cap defining a boundary of the sealed material-compression space. Finally, the upper and lower mold portions are separated and a container closure comprising a cap made of a relatively hard plastics material and an overmolded grip portion made of a relatively softer elastomeric material is ejected from the closure mold.

Additional features of the present disclosure will become apparent to those skilled in the art upon consideration of the following detailed description of preferred embodiments exemplifying the best mode of carrying out the disclosure as presently perceived.

### BRIEF DESCRIPTION OF THE DRAWINGS

The detailed description particularly refers to the accompanying figures in which:

FIG. 1 is a block diagram illustrating a process in accordance with the present disclosure for compression molding an elastomeric material in, for example, two stages to form a soft grip portion on an exterior portion of a hard cap to produce a container closure made of relatively harder and softer materials;

FIG. 2 is a perspective view of a first embodiment of a container closure made in accordance with the apparatus and methods disclosed herein and adapted to be mounted on an underlying container to close an open mouth (not shown) formed in the container;

FIG. 3 is a sectional view of the container closure of FIG. 2 showing a soft exterior thin-walled grip portion covering top and upper side portions of an underlying cap made of a relatively harder plastics material and formed to include an interior thread and a lower tamper-evident band;

FIG. 4 is a perspective view of a second embodiment of a container closure made in accordance with the apparatus and methods disclosed herein;

FIG. 5 is a sectional view of the container closure of FIG. 4 showing a soft exterior thin-walled grip portion covering top and (unribbed and ribbed) upper side portions of an underlying cap made of a relatively harder plastics material and formed to include an interior thread and a lower tamper-evident band;

FIGS. 6-11 show a series of steps in an illustrative method in accordance with the present disclosure to form the container closure shown in FIGS. 4 and 5;

FIG. 6 is a sectional elevation view showing an inverted cap made of a molded plastics material before it is transported to a molding station;

FIG. 7 is a view similar to FIG. 6 showing downward movement of a workpiece holder aligned with the underlying inverted cap of FIG. 6 toward an opening into an interior region formed in the inverted cap;

FIG. 8 is a view similar to FIGS. 6 and 7 showing mating engagement of the workpiece holder with the inverted cap to mount the inverted cap on a free end of the workpiece holder in preparation for using the workpiece holder to move the inverted cap to a closure mold;

FIG. 9 is a view similar to FIGS. 6-8 showing a gob made of a relatively soft elastomeric material located on a floor included in a lower mold portion and in a mold cavity formed in the lower mold portion and showing a multi-part upper mold portion overlying the lower mold portion and comprising the workpiece holder, the inverted cap coupled to the workpiece holder, a holder mover coupled to the underlying workpiece holder, an outer sleeve arranged to surround portions of the workpiece holder and inverted cap and supported for movement relative to the workpiece holder and the inverted cap, and a sleeve-biasing spring coupled to the outer sleeve;

FIG. 10 is a view similar to FIG. 9 showing a first stage of a molding process in accordance with the present disclosure after the outer sleeve of the upper mold portion has been moved downwardly to mate with the underlying lower mold portion and the inverted cap has been moved downwardly into the mold cavity formed in the lower mold portion by the workpiece holder and holder mover to compress the gob of soft elastomeric material located in the mold cavity to cause the soft elastomeric material to begin to flow in a sealed material-compression space provided between the inverted cap, the outer sleeve, and the lower mold portion;

FIG. 11 is a view similar to FIGS. 9 and 10 showing downward movement of the workpiece holder relative to the outer sleeve to cause further downward movement of the inverted cap relative to the mated outer sleeve and lower mold portion to compress the soft elastomeric material further to distribute that elastomeric material further along top and side portions of the cap and fill fully the sealed material-compression space provided between the inverted cap, the outer sleeve, and the lower mold portion so as to form the overmolded soft grip portion in that sealed material-compression space on an exterior portion of the hard cap;

FIG. 12 is an enlarged view of the molding station in the first-stage condition shown in FIG. 10, with portions of the inverted cap and workpiece holder broken away to show mating and sealing engagement between a radially outwardly facing annular shut-off surface on the cap and a radially inwardly facing interior wall of the outer sleeve to block any flow of compressed elastomeric material therebetween during overmolding of the soft grip portion (made of the elastomeric material) onto the relatively hard cap and showing that, during this first stage of compression molding, the sealed material-compression space provided between the inverted cap, the outer sleeve, and the lower mold portion is not yet fully filled with the flowing elastomeric material and the top wall of the grip portion being overmolded is thicker than a companion side wall; and

FIG. 13 is an enlarged view of the molding station in the second-stage condition shown in FIG. 11, with portions of the inverted cap and workpiece holder broken away to show that the compressed elastomeric material is retained in the sealed material-compression space provided between the inverted cap, the outer sleeve, and the lower mold portion by a fluid-tight seal established by mating and sealing engagement of the radially outwardly facing annular shut-off surface on the cap and the radially inwardly facing annular interior wall of the movable outer sleeve after the inverted cap has been moved by the workpiece holder relative to the lower mold portion to assume its final position forming the grip portion in the sealed material-compression space on an exterior surface of the cap.

### DETAILED DESCRIPTION

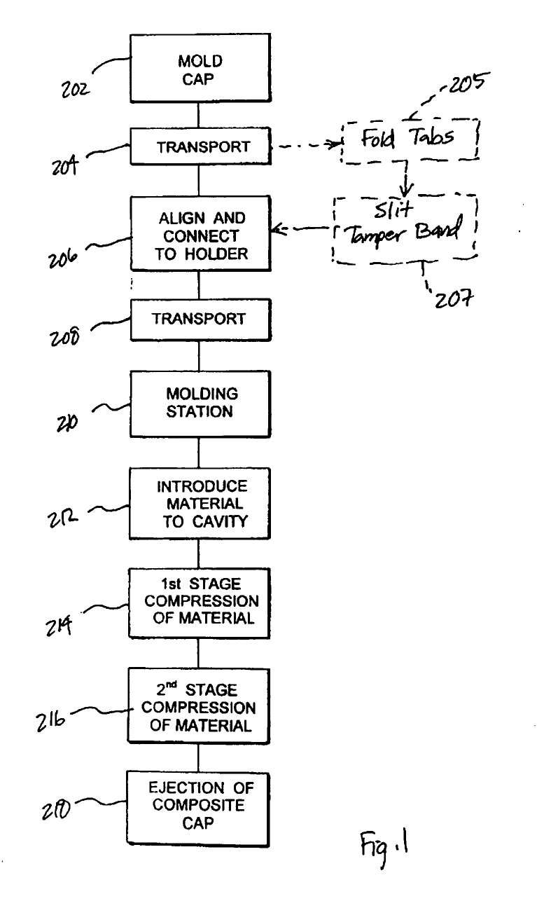

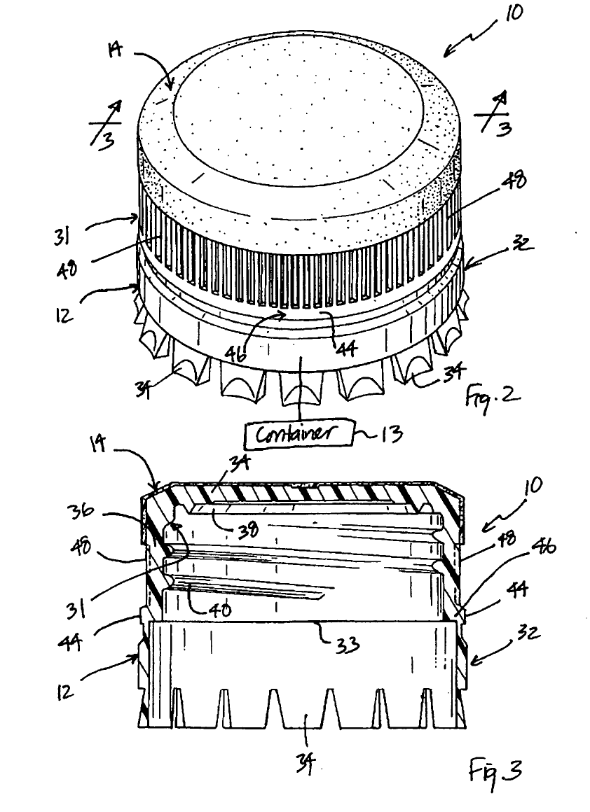

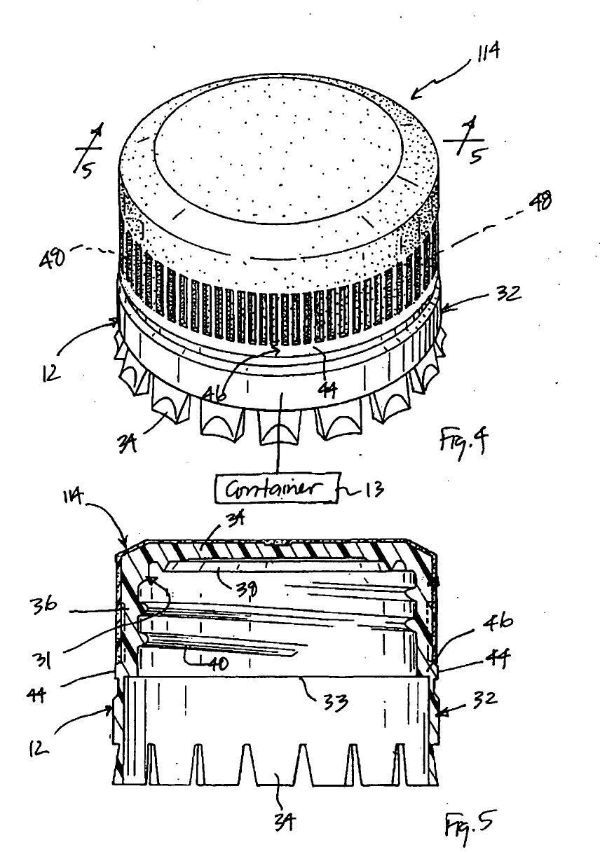

Methods of compression molding an elastomeric material to produce a container closure comprising a cap made of a plastics material and an outer grip portion made of a relatively softer elastomeric material are described and illustrated in this disclosure. An illustrative first container closure 10 comprising a cap 12 and an outer grip portion 14 is shown in FIGS. 2 and 3, while an illustrative second container closure 100 comprising cap 12 and an outer grip portion 114 is shown in FIGS. 4 and 5. A compression molding process in accordance with the present disclosure is shown diagrammatically in FIG. 1 and illustratively in FIGS. 6-11 with reference to the enlarged views provided in FIGS. 12 and 13 to show a sealed material-compression space 20 formed between upper and lower mold portions 21, 22 included in a closure mold 24.

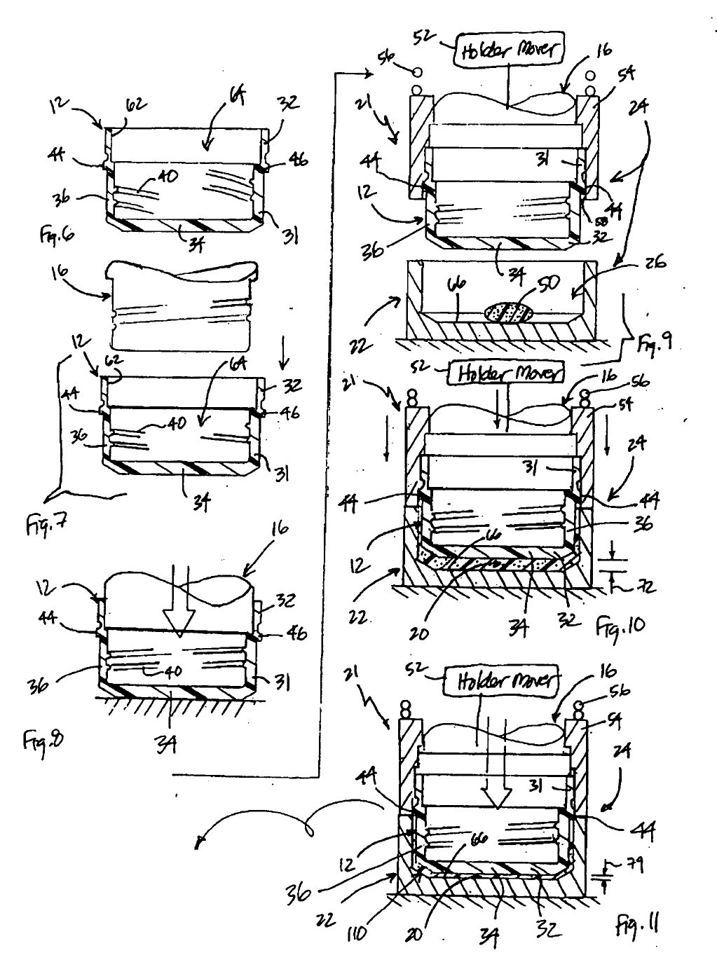

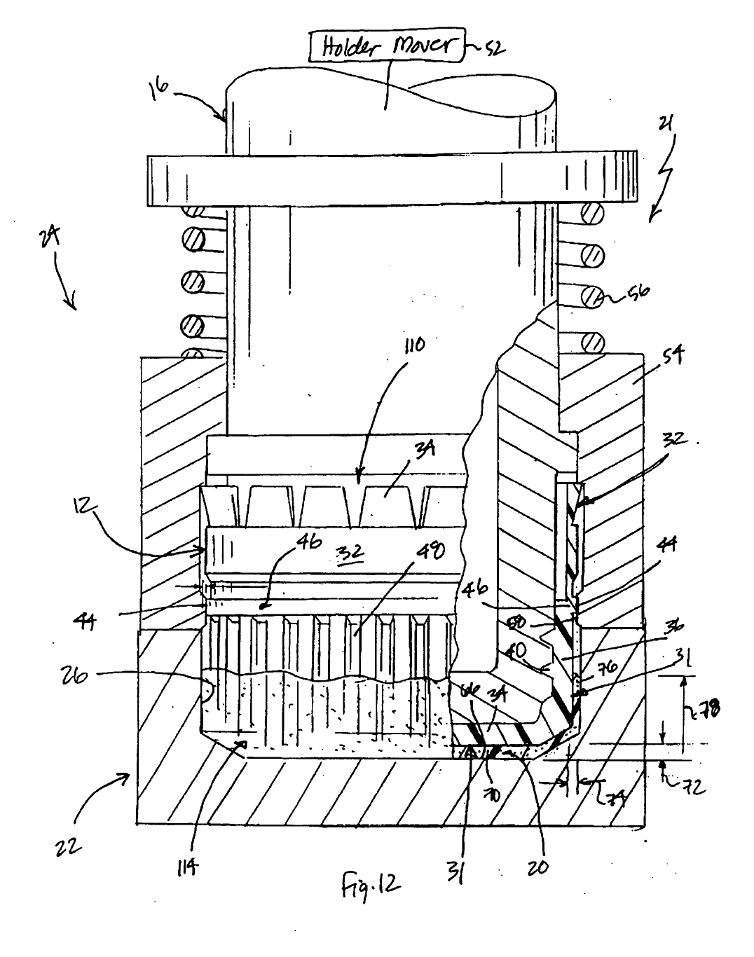

A series of steps for making a container closure (e.g., closure 10 shown in FIGS. 2 and 3 or closure 110 shown in FIGS. 4 and 5) are described diagrammatically in FIG. 1. As suggested in FIG. 1, a cap (e.g., cap 12 shown in FIG. 6) is molded or otherwise formed at a first molding station 202. Cap 12 is then moved by transport system 204 to a cap-mounting station 206. Cap 12 is aligned with and mounted on a workpiece holder (e.g., workpiece holder 16) as shown in FIGS. 7 and 12 at the cap-mounting station 206. Workpiece holder 16 carrying cap 12 is moved by transport system 208 to molding station 210. An elastomeric material that will be used to form outer grip portion 14 is introduced by a material dispenser 212 into a mold cavity (e.g., mold cavity 26 formed in lower mold portion 22 as shown in FIG. 9) provided at molding station 210. A punch 28 comprising cap 12 and workpiece holder 16 is moved by a holder mover (e.g., holder mover 52 shown diagrammatically in FIG. 9) to compress the elastomeric material in a sealed material-compression space 20 formed in closure mold 24 between cap 12 and lower mold portion 22 during a first compression stage 214 and then again during a second compression stage 216. Finally, a container closure 110 comprising cap 12 and an outer grip portion 114 overmolded onto an exterior portion of cap 12 is ejected from closure mold 24 by ejector 218.

As suggested in FIG. 1, in some cases wherein cap 12 is formed to include a lid 31 and a frangible tamper-evident band (e.g., tamper-evident band 32 shown in FIG. 7), two extra process steps are added. A tab folder 205 is used to fold tabs 34 included in tamper-evident band 32. A band slitter 207 is used to slit tamper-evident band 32 to produce slits (not shown) between lid 31 and tamper-evident band 32 to provide a frangible connection between lid 31 and tamper-evident band 32.

A closure cap 10 in accordance with a first embodiment of the present disclosure is shown, for example, in FIGS. 2 and 3. A closure cap 110 in accordance with a second embodiment of the present disclosure is shown, for example, in FIGS. 4 and 5. Both of closure caps 10 and 110 include a cap 12 made, for example, of a plastics material and an outer grip portion 14 or 114 made, for example, of a relatively softer elastomeric material and overmolded on an exterior portion of cap 12. Cap 12 is adapted to be mounted on an underlying container 13 to close an opening (not shown) into an interior region (not shown) of container 13 as suggested in FIGS. 2 and 4. As shown in the drawings, outer grip portion 114 has a longer side wall than outer grip portion 14.

Cap 12 includes a lid 31 and a tamper-evident band 32 coupled to lid 31 along a frangible line 33 as suggested in FIGS. 3 and 5. Lid 31 includes a top wall 34 and a downwardly extending annular side wall 36 coupled to a perimeter edge of top wall 34. A downwardly extending seal ring 38 is appended to an underside of top wall 34. A radially inwardly extending helical thread 40 (or any suitable thread or fastener segments or means) is appended to an interior surface 42 of annular side wall 36.

A radially outwardly facing shut-off surface 44 is provided on a radially outwardly extending annular protrusion 46 appended to annular side wall 36 as shown best in FIGS. 3 and 5. Shut-off surface 44 is located near and, for example, just above frangible line 33 as shown in FIGS. 3 and 5. Vertically extending ribs 48 are provided on an exterior portion of annular side wall 36 and located above annular protrusion 46 as suggested in FIGS. 2-5. Shut-off surface 44 plays a role in establishing sealed material-compression space 20 in closure mold 24 as described herein and illustrated in the drawings.

As suggested in FIGS. 2 and 3, overmolded outer grip portion 14 does not cover vertically extending ribs 48 formed in lid 31 of cap 12 included in closure 10. In contrast, as suggested in FIGS. 4 and 5, overmolded outer grip portion 114 does cover vertically extending ribs 48 formed in lid 31 of cap 12 included in closure 110. It is within the scope of this disclosure to use either a cap 12 including a lid 31 and a tamper-evident band 32, a cap 12 including a lid 31 and another suitable tamper-evident band (not shown), or a cap 12 including only a lid 31 as shown or of another suitable design.

As suggested in FIGS. 9, 12, and 13, an illustrative closure mold 24 comprises an upper mold portion 21 and a companion lower mold portion 22. Relative movement between upper and lower mold portions 21, 22 generated using any suitable means is provided to squeeze or otherwise deform a gob 50 of elastomeric material placed in a mold cavity 26 formed in lower mold portion 22 to overmold outer grip portion 14 or 114 onto a cap 12 that has been inverted and mated with other components to form upper mold portion 21 as suggested in FIGS. 9-11, 12, and 13. Downward movement of upper mold portion 21 toward stationary lower mold portion 22 is shown in FIGS. 9-13. It is within the scope of this disclosure to move lower mold portion 22 upwardly toward a stationary upper mold portion to overmold outer grip portion 14 or 114 on cap 12 in accordance with an alternative compression molding process. Gob 50 can be a pellet, a segment of an extrusion, or any other suitable bundle of compressible elastomeric material suitable for use in a compression molding process.

In an illustrative embodiment, upper mold portion 21 comprises a workpiece holder 16, an inverted cap 12 coupled to workpiece holder 16, a holder mover 52 coupled to workpiece holder 16, an outer sleeve 54 arranged to surround portions of workpiece holder 16 and inverted cap 12 and supported for movement relative to workpiece holder 16 and inverted cap 12, and a sleeve-biasing spring 56 coupled to outer sleeve 54 as suggested in FIGS. 9, 12, and 13. During assembly of the components used to produce upper mold portion 20, an interference fit is established between annular protrusion 46 and outer sleeve 54 characterized by 0.009 inch radial compression of cap 12 in an opening defined by annular interior wall 58 of outer sleeve 54.

As suggested in FIGS. 9-13, radially outwardly facing shut-off surface 44 of annular protrusion 46 included in inverted cap 12 mates with an opposing annular interior wall 58 of outer sleeve 54 to establish a fluid-tight seal therebetween. Such a seal remains in place even during, for example, up and down movement of workpiece holder 16 and inverted cap 12 relative to the surrounding outer sleeve 54 as suggested in FIGS. 9-13. In effect, such a seal functions to seal material-compression space 20 containing gob 50 to limit or otherwise prevent any overflashing that might otherwise occur during overmolding of outer grip portion 14 or 114 onto cap 12. It is within the scope of this disclosure to reconfigure upper mold portion 21 to produce an axial, angular, or tapered seal instead of the radial seal that is shown and described to enhance sealing characteristics of sealed material-compression space 20.

A series of steps in an illustrative method in accordance with the present disclosure is shown in FIGS. 6-11 to form container closure 110 shown in FIGS. 4 and 5. An inverted cap 12 made of a molded plastics material is shown in FIG. 6 before it is transported to a molding station. Downward movement of a workpiece holder 16 aligned with underlying inverted cap 12 toward an opening 62 into an interior region 64 formed in inverted cap 12 is shown in FIG. 7. Mating engagement of workpiece holder 16 with inverted cap 12 to mount inverted cap 12 on a free end of workpiece holder 16 in preparation for using workpiece holder 16 to move inverted cap 12 to a closure mold 24 is shown in FIG. 8.

A gob 50 made of a relatively soft elastomeric material is shown in FIG. 9 located on a floor 66 included in lower mold portion 22 and in mold cavity 26 formed in lower mold portion 22. A first stage of a molding process in accordance with the present disclosure is shown in FIG. 10 after outer sleeve 54 of upper mold portion 21 has been moved downwardly to mate with the underlying lower mold portion 22 and inverted cap 12 has been moved downwardly into mold cavity 26 formed in lower mold portion 22 by workpiece holder 16 and holder mover 52 to compress the gob 50 of soft elastomeric material located in mold cavity 26 to cause the soft elastomeric material to begin to flow in a sealed material-compression space 20 provided between inverted cap 12, outer sleeve 54, and lower mold portion 22.

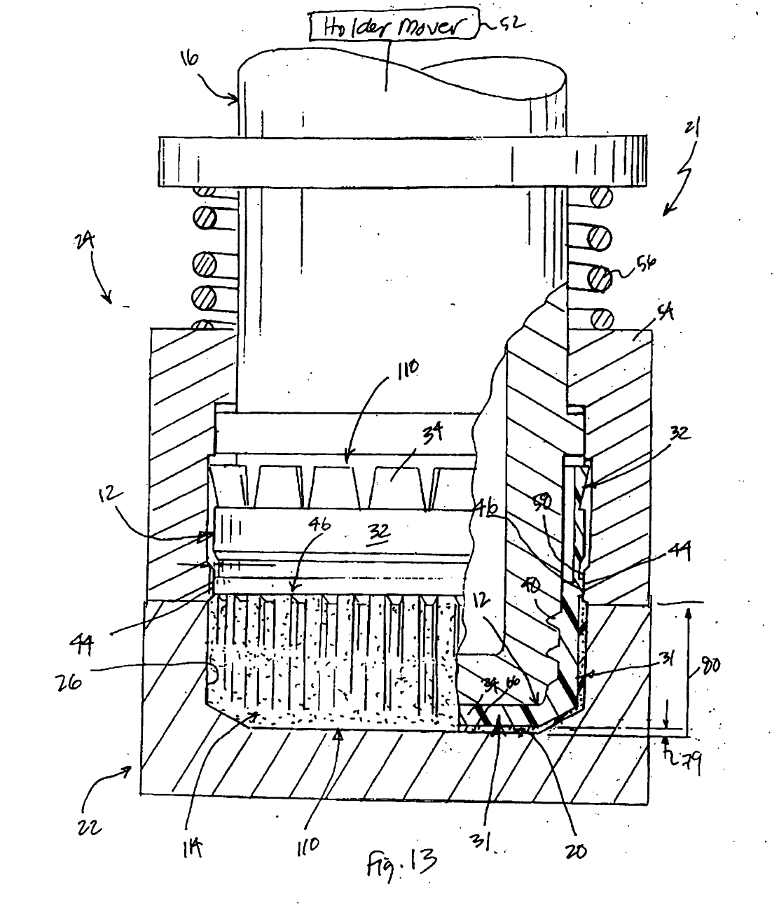

As shown in FIG. 11, in a second stage of a molding process in accordance with the present disclosure, downward movement of workpiece holder 16 relative to outer sleeve 54 to compress spring 56 and cause further downward movement of inverted cap 12 relative to the mated outer sleeve 54 and lower mold portion 22 to compress the soft elastomeric material further to distribute that elastomeric material further along top and side portions of cap 12 and fill fully the sealed material-compression space 20 provided between inverted cap 12, outer sleeve 54, and lower mold portion 22 so as to form the overmolded soft grip portion 114 in that sealed material-compression space 20 on an exterior portion of the hard cap 12.

An enlarged view of the molding station in the first-stage condition shown in FIG. 10 is provided in FIG. 12. Portions of inverted cap 12 and workpiece holder 16 are broken away to show mating and sealing engagement between radially outwardly facing annular shut-off surface 44 on cap 12 and a radially inwardly facing interior wall 58 of outer sleeve 54 to block any flow of compressed elastomeric material therebetween during overmolding of the soft grip portion 114 (made of the elastomeric material) onto the relatively hard cap 12. During this first stage of compression molding, the sealed material-compression space 20 provided between inverted cap 12, outer sleeve 54, and lower mold portion 22 is not yet fully filled with the flowing elastomeric material and the top wall 70 of the grip portion 114 being overmolded has a thickness 72 that is thicker than a thickness 74 of companion side wall 76. At this stage, deformed elastomeric material has moved upwardly in material-compression space 20 to reach elevation 78 shown in FIG. 12.

An enlarged view of the molding station in the second-stage condition shown in FIG. 11 is provided in FIG. 13. Portions of inverted cap 12 and workpiece holder 16 are broken away to show that the compressed elastomeric material is retained in the material-compression space 20 provided between inverted cap 12, outer sleeve 54, and lower mold portion 22 by a fluid-tight seal established by mating and sealing engagement of the radially outwardly facing annular shut-off surface 44 on cap 12 and the radially inwardly facing annular interior wall 58 of outer sleeve 54 after inverted cap 12 has been moved by workpiece holder 16 relative to lower mold portion 22 to assume its final position forming the grip portion 114 in the sealed material-compression space 20 on an exterior surface of cap 12. The uniform thickness of most of grip portion 114 is thickness 79. At this stage, deformed elastomeric material has moved upwardly in material-compression space 20 to reach elevation 80 shown in FIG. 13.

In this disclosure, a compression-molded material is molded under compression over a rigid base part molded of polypropylene. The base part can be injection-molded or compression-molded. In the embodiment of FIGS. 4 and 5, overmolded outer grip portion 114 covers external ribs 48 included in cap 12 to provide grip fingers made of elastomeric material. It is within the scope of this disclosure to vary the side wall coverage of outer grip portion 14, 114 on cap 12.

Outer grip portion 14, 114 is overmolded onto an exterior surface of cap 12 to provide a smooth and resilient tactile feel to users of closure 10, 110. Using the process disclosed herein, manufacturing costs are minimized by producing cap 12 and overmolded outer grip 14, 114 directly in line. Closure 10, 110 is compatible with downstream manufacturing processing and also is compatible with customers' container filling lines and part conveyance. A wide variety of elastomeric materials and surface finishes can be applied depending on final desired characteristics and molding properties.

1. A process of producing a container closure, the process comprising the steps of
depositing a gob of elastomeric material in the cavity of a mold and
moving an inverted cap downwardly into the cavity of the mold to squeeze the elastomeric material between the downwardly moving cap and the mold such that the elastomeric material flows along the top wall and side wall of the cap to form a container closure comprising the cap and an overmolded grip portion made of the elastomeric material.

2. The process of the claim 1, wherein the step of moving the cap downwardly into the cavity of the mold comprises the step of moving the cap downwardly into the cavity of the mold in a first stage of compression molding wherein the elastomeric material is squeezed between the downwardly moving cap and the mold to cause the elastomeric material to flow along the top wall and side wall of the cap and the subsequent step of moving the cap downwardly further into the cavity of the mold in a second stage of compression molding to further squeeze the elastomeric material between the downwardly moving cap and the mold to cause the elastomeric material to flow further along the top wall and the side wall of the cap.

3. The process of claim 1, wherein the mold includes an upper mold portion that mates with a lower mold portion to form a sealed material-compression space therebetween.

4. The process of claim 3, wherein the upper mold portion includes a workpiece holder and the cap is mounted on the workpiece holder to move therewith during the moving step.

5. The process of claim 3, wherein the gob of elastomeric material is deposited on a floor of the lower mold portion of the mold.

6. The process of claim 3, wherein the upper mold portion includes an outer sleeve adapted to establish a fluid-tight annular seal between the cap and the outer sleeve.

7. The process of the claim 6, wherein, when the upper mold portion is mated with the lower mold portion and the cap, the outer sleeve, and the lower mold portion cooperate to define the sealed material-compression space.

8. The process of claim 1, wherein the mold comprises a multi-part upper mold portion overlying a lower mold portion, the upper mold portion includes a workpiece holder, the cap is coupled to the workpiece holder, an outer sleeve is arranged to surround portions of the workpiece holder and the cap, the sleeve is supported for movement relative to the workpiece holder and the cap, the lower mold portion includes the cavity for receiving the gob of elastomeric material.

9. The process of claim 8, wherein the step of moving the cap downwardly into the cavity of the mold comprises the steps of moving the upper mold portion downwardly to mate with the lower mold portion while moving the cap downwardly into the cavity of the lower mold portion in a first stage of compression molding wherein the elastomeric material is squeezed between the downwardly moving cap and the lower mold portion to cause the elastomeric material to flow along the top wall and side wall of the cap, and the subsequent step of moving the workpiece holder relative to the outer sleeve and causing further downward movement of the cap into the cavity of the lower mold portion in a second stage of compression molding to further squeeze the elastomeric material between the downwardly moving cap and the lower mold portion and cause the elastomeric material to flow further along the top wall and the side wall of the cap.

10. The process of claim 9, wherein, when the upper mold portion is mated with the lower mold portion, the cap, outer sleeve and lower mold portion cooperate to define a sealed material-compression space, the sealed material-compression space not being filled fully with the flowing elastomeric material during the first stage of compression molding, and the sealed material-compression space is filled substantially with compressed elastomeric material during the second stage of compression molding.

11. The process of claim 9, wherein the cap includes a radially outwardly extending annular protrusion having a radially outwardly facing annular shut-off surface in mating and sealing engagement with an inwardly facing interior wall of the outer sleeve to block flow of compressed elastomeric material therebetween and to define a sealed material-compression space and the annular protrusion maintains the seal with the outer sleeve as the workpiece holder and cap move with respect to the outer sleeve during the second stage of compression molding.

12. The process of claim 9, wherein the upper mold portion includes a spring coupled to the outer sleeve, and further comprising the step of compressing the spring during the second stage of compression molding as the workpiece holder causes further downward movement of the cap into the cavity of the lower mold portion.

13. The process of claim 1, further comprising the steps of molding the cap, and mounting the cap on a workpiece holder, prior to moving the cap downwardly into the cavity of the mold.

14. The process of claim 13, further comprising the steps of forming the cap to include a lid and a tamper-evident band with tabs, providing one or more slits between the lid and the tamper-evident band to provide a frangible connection between the lid and the tamper-evident band, and folding the tabs of the tamper-evident band.

15. The process of claim 13, further comprising the steps of moving the molded cap by a transport system to a cap mounting station for mounting on the workpiece holder, and moving the workpiece holder carrying the cap by a transport system to a molding station wherein the cap is inserted downwardly into the cavity of the mold.

16. The process of claim 1, wherein the cap is made of a plastics material, and the elastomeric material forming the grip portion is relatively softer than the plastics material of the cap.

17. A process of producing a container closure, the process comprising the steps of
providing a closure mold including an upper mold portion adapted to mate with an underlying lower mold portion to form a sealed material-compression space therebetween, the upper mold portion including an inverted cap mounted on a workpiece holder, the cap having a side wall trapped between the workpiece holder and a surrounding outer sleeve of the upper mold portion to establish a fluid-tight annular seal between the inverted cap and the surrounding outer sleeve,
depositing a gob of elastomeric material in a cavity formed in the lower mold portion,
moving the inverted cap downwardly into the cavity in the lower mold portion in a first stage of compression molding to squeeze the gob of elastomeric material between the lower mold portion and the inverted cap and cause the elastomeric material to flow along the top wall and side wall of the cap to fill some but not all of the sealed material-compression space, and
moving the inverted cap downwardly further into the cavity in the lower mold portion in a second stage of compression molding to further squeeze the elastomeric material and cause the elastomeric material to further flow along the top wall and side wall of the cap to substantially fill all of the sealed material-compression space and thereby form an overmolded grip portion on the top wall and side wall portions of the cap generally defining the boundary of the sealed material-compression space.

18. The process of claim 17, further comprising the step of mounting the inverted cap on a free end of the workpiece holder.

19. The process of 17, wherein the workpiece holder and the cap are moved during the first compression stage and then again during the second compression stage by a holder mover.

20. The process of claim 17, wherein the cap includes a side wall and an annular protrusion extending outwardly from the side wall and the protrusion is in mating engagement with the surrounding outer sleeve to provide the fluid-tight annular seal with the sleeve and to block flow of compressed elastomeric material therebetween.

21. The process of claim 17, wherein the outer sleeve of the upper mold portion is mated to the lower mold portion during the first stage of compression molding.

22. The process of claim 21, wherein the workpiece holder and the cap move with respect to the sleeve during the second stage of compression molding.

23. The process of claim 21, wherein a top wall of the grip portion has a thickness that is thicker than the thickness of a side wall of the grip portion after completion of the first stage of compression molding.

24. The process of claim 22, wherein a top wall of the grip portion and a side wall of the grip portion have a relatively uniform thickness after completion of the second stage of compression molding.

25. A process of producing a container closure, the process comprising the steps of
providing a cap formed from a relatively hard plastic material adapted to be mounted on an underlying container, the cap including a lid having a top wall, a downwardly extending annular side wall, and an outwardly extending annular protrusion appended to the annular side wall of the lid having an outwardly facing shut-off surface,
mounting the cap on a workpiece holder of a closure mold, the closure mold comprising an upper mold portion and a lower mold portion, the upper mold portion including the workpiece holder and an outer sleeve adapted to surround portions of the workpiece holder and cap,
mating the upper mold portion to the lower mold portion such that the lower mold portion, the cap and the outer sleeve cooperate to define a sealed material-compression space, the shut-off surface being in mating and sealing engagement with the outer sleeve to block the flow of compressed elastomeric material therebetween, and
squeezing a gob of elastomeric material in the sealed material-compression space between the cap and the lower mold portion to cause the elastomeric material to flow along the top wall and side wall of the cap and thereby form an overmolded grip portion on the top wall and side wall portions of the cap, the elastomeric material forming a grip portion.

26. The process of claim 25, further comprising the step of inserting the cap into a cavity of the lower mold as the upper mold portion is mated with the lower mold portion to thereby squeeze the elastomeric material between the cap and the lower mold portion during a first stage of compression molding.

27. The process of claim 26, further comprising the step of further inserting the cap into the cavity of the lower mold portion during a second stage of compression molding after the upper mold portion is mated to the lower mold portion wherein the elastomeric material is further squeezed between the cap and lower mold portion to fill substantially the sealed material-compression space with compressed elastomeric material.

28. The process of claim 27, further comprising the step of separating the upper and lower mold portions and ejecting the container closure, the container closure comprising a cap made of a relatively hard plastics material and an overmolded grip portion made of a relatively softer elastomeric material.

29. A process of molding a container closure comprises the steps of
depositing a gob of elastomeric material in a mold cavity defined between upper and lower mold portions and then
deforming the gob in a mold cavity formed in a closure mold to produce a grip portion overmolded onto a cap made of a plastics material, wherein the closure mold includes an upper mold portion that mates with an underlying lower mold portion to form a sealed material-compression space therebetween, the upper mold portion includes an inverted cap mounted on a workpiece holder and provided with a side wall trapped between the workpiece holder and a surrounding outer sleeve to establish a fluid-tight annular seal between the inverted cap and the surrounding outer sleeve, when the upper mold portion is mated with the lower mold portion, the inverted cap, the outer sleeve, and the lower mold portion cooperate to define a sealed material-compression space, a gob of elastomeric material is placed in a cavity formed in the lower mold portion during the depositing step so that the gob will be compressed in the scaled material-compression space during the overmolding process, the gob is squeezed between the stationary lower mold portion and the downwardly moving inverted cap during the deforming step to cause the elastomeric material to flow along the top wall and side wall of the cap and to fill some but not all of the sealed material-compressing space in response to downward movement of the upper mold portion to cause the outer sleeve to mate with the lower mold portion during a first stage of compression molding, in a second stage of compression molding, the inverted cap is moved downwardly further into the cavity formed in the lower mold portion during the deforming step to squeeze the elastomeric material even more so as to cause the elastomeric material to deform further and flow along the top wall and side wall of the cap to fill all of the sealed material-compression space so as to form an overmolded relatively soft outer grip portion therein on top wall and side wall portions of the cap defining a boundary of the sealed material-compression space, and further comprising the step of separating the upper and lower mold portions and ejecting a container closure comprising a cap made of a relatively hard plastics material and an overmolded grip portion made of a relatively softer elastomeric material from the closure mold.

30. A container closure adapted to be mounted on a container to close an opening into an interior region of the container, the container closure comprising
a cap made of a plastics material, the cap including a lid having a top wall, a downwardly extending side wall coupled to a perimeter edge of the top wall, and an outwardly extending annular protrusion appended to the side wall and including an outwardly facing shut-off surface, and
an outer grip portion made of an elastomeric material that is relatively softer than the plastics material of the cap, the outer grip portion including a top wall overmolded on the top wall of the lid and a side wall overmolded on the side wall of the lid.

31. The container closure of claim 30, wherein the side wall of the lid includes a plurality of vertical ribs on an exterior portion of the side wall of the lid between the top wall of the lid and the annular protrusion.

32. The container closure of claim 31, wherein the side wall of the outer grip portion does not cover the ribs of the lid.

33. The container closure of claim 30, wherein the side wall of the outer grip portion extends along the side wall of the lid to the annular protrusion of the cap.
